(19) United States
(12) Patent Application Publication
(10) Pub. No.: US 2026/0369117 A1
(43) Pub. Date: Nov. 19, 2026

(54) COMMUNICATION SYSTEM AND METHOD FOR ACCESS BARRIERS

(71) Applicant: The Government of the United States of America, as represented by the Secretary of Homeland Security, Washington, DC (US)

(72) Inventor: Angela Lundberg, Port Norris, NJ (US)

(73) Assignee: The Government of the United States of America, as represented by the Secretary of Homeland Security, Washington, DC (US)

(21) Appl. No.: 19/677,148

(22) Filed: May 14, 2026

Related U.S. Application Data
(60) Provisional application No. 63/806,216, filed on May 15, 2025.

(51) Int. Cl. G07C 9/32

(52) U.S. Cl. CPC G07C 9/32

(57) ABSTRACT

In an example, a communication solutions method comprises: identifying a communication need to provide a communication solution to an individual being screened at an access control checkpoint; selecting a communication solutions content from a plurality of communication solutions contents stored in a computer storage to provide to the individual based on the communication need, the plurality of communication solutions contents having been created, prior to identifying the communication need, to communicate a plurality of screening scenarios to be performed to determine whether to grant access to the individual at the access control checkpoint, each communication solutions content utilizing one or more corresponding computer user interfaces to communicate the communication solutions content; electronically retrieving, by a communication solutions system, the selected communication solutions content from the computer storage; and providing the selected communication solutions content to the individual, by the communication solutions system, using the one or more corresponding computer user interfaces corresponding to the selected communication solutions content.

### CROSS-REFERENCE TO RELATED APPLICATIONS

The application is a nonprovisional of and claims the benefit of priority from U.S. Provisional Patent Application No. 63/806,216 filed on May 15, 2025, entitled COMMUNICATION SYSTEM AND METHOD FOR ACCESS BARRIERS, the entire disclosure of which is incorporated herein by reference.

### SUMMARY STATEMENT OF GOVERNMENT INTEREST

The present invention was made with support from the United States Department of Homeland Security (DHS) and by an employee of DHS in the performance of their official duties. The U.S. Government has certain rights in this invention.

### FIELD

The discussion below relates generally to efficiently facilitating ingress and egress of people and objects through barriers and, more particularly, to methods and systems for overcoming communication problems that occur at barriers such as those in a security setting including security screening, checkpoint access, and the like.

### BACKGROUND

At international checkpoints, language barriers can be commonplace between passengers and security officers. Effective and prompt communication at security checkpoints is critical for security, safety, and passenger flow. While some instructions are currently depicted using visual descriptions leading up to the checkpoint, instructions on the secure side of the checkpoint relies primarily on spoken communication. In particular, the resolution of an on-person alarm indicator relies on spoken communication between a security screening personnel and the passenger. Pat-downs by the security officer such as a Transportation Security Officer (TSO) can often involve the necessity to contact sensitive areas of the body such as the groin. It is important that the TSO communicate to the passenger of the process of such sensitive and potentially intrusive physical inspection so as to avoid misunderstanding and conflict. While overcoming the language barrier is critical at international checkpoints, it can be no less beneficial in other settings such as domestic transportation hubs but can also improve communications at all airports as well as other settings. In addition, communication barriers are not limited to language, but may involve the hearing-impaired, the visually impaired, etc.

### SUMMARY

Embodiments of the present invention are directed to a communication solutions method and a communication solutions system for overcoming communication barriers in a security screening setting.

In accordance with an aspect, a communication solutions method comprises: identifying a communication need to provide a communication solution to an individual being screened at an access control checkpoint; selecting a communication solutions content from a plurality of communication solutions contents stored in a computer storage to provide to the individual based on the communication need, the plurality of communication solutions contents having been created, prior to identifying the communication need, to communicate a plurality of screening scenarios to be performed to determine whether to grant access to the individual at the access control checkpoint, each communication solutions content utilizing one or more corresponding computer user interfaces to communicate the communication solutions content; electronically retrieving, by a communication solutions system, the selected communication solutions content from the computer storage; and providing the selected communication solutions content to the individual, by the communication solutions system, using one or more computer user interfaces corresponding to the selected communication solutions content.

Another aspect is directed to a communication solutions system comprising a processor, a memory, and a program, The program is executable by the processor to: identify a communication need to provide a communication solution to an individual being screened at an access control checkpoint; select a communication solutions content from a plurality of communication solutions contents stored in a computer storage to provide to the individual based on the communication need, the plurality of communication solutions contents having been created, prior to identifying the communication need, to communicate a plurality of screening scenarios to be performed to determine whether to grant access to the individual at the access control checkpoint, each communication solutions content utilizing one or more corresponding computer user interfaces to communicate the communication solutions content; electronically retrieve the selected communication solutions content from the computer storage; and provide the selected communication solutions content to the individual using one or more computer user interfaces corresponding to the selected communication solutions content.

Other features and aspects of various examples and embodiments will become apparent to those of ordinary skill in the art from the following detailed description which discloses, in conjunction with the accompanying drawings, examples that explain features in accordance with embodiments. This summary is not intended to identify key or essential features, nor is it intended to limit the scope of the invention, which is defined solely by the claims.

### BRIEF DESCRIPTION OF THE DRAWINGS

The attached drawings help explain the embodiments described below.

FIG. 1 shows examples of communication solutions for access control screening.

FIG. 2 shows an example of a visual of a noninvasive pat down of a person using a handheld metal detector wand for (A) front scanning and (B) back scanning.

FIG. 3 shows an example of a visual of an invasive pat down of the (A) lower body and (B) upper body of a person.

FIG. 4 shows an example of an approach to develop a communication solution at an access control screening.

FIG. 5 shows an example of a system of providing communication solutions at an access control checkpoint.

FIG. 6 shows an example of a flow diagram illustrating a communication solutions method.

FIG. 7 illustrates a computing system including logic according to an embodiment.

### DETAILED DESCRIPTION

A number of examples or embodiments of the present invention are described, and it should be appreciated that the present invention provides many applicable inventive concepts that can be embodied in a variety of ways. The embodiments discussed herein are merely illustrative of ways to make and use the invention and are not intended to limit the scope of the invention. Rather, as will be appreciated by one of skill in the art, the teachings and disclosures herein can be combined or rearranged with other portions of this disclosure along with the knowledge of one of ordinary skill in the art.

Embodiments of the present invention are directed to a communication solutions method and a communication solutions system for overcoming communication barriers in a security setting such as security screening, checkpoint access, and the like.

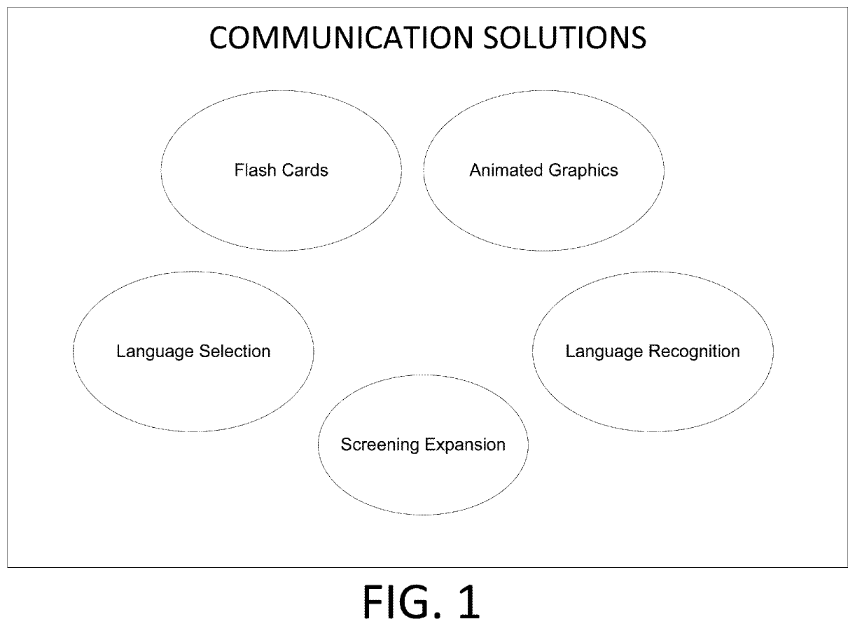

FIG. 1 shows examples of communication solutions for access control screening. They include flash cards, animated graphics, language selection, language recognition, and screening expansion.

### Solution Level 1—Flash Cards (Groundwork)

A first solution level (Level 1 solution) of the communication solutions system involves generating at least one flash card or a series of flash cards (i.e., communication solutions content) which are designed to help passengers visualize the pat-down process for a range of locations, which may be combined with thorough training of the security personnel on how to utilize the flash cards. The security officer may decide to present the series of flash cards in a particular order, for instance, based on the actual sequence of screening processes to be performed or the level of intrusiveness from the lowest to the highest. This method provides the security personnel with a quick and simple solution that can significantly increase their ability to communicate. It is relatively easy to implement and store and can be done rather quickly.

In an alternative embodiment, the flash cards may be presented in electronic form instead of physical form. The electronic flash cards may be presented on electronic displays such as those provided on mobile phones, tablets, personal computers, and the like. The arrangement of the communication solutions content can be performed manually by the security officer or automatically by a processor. One example involves arranging the communication solutions content (electronic flash cards) to be presented in a sequential order to the individual, from a least intrusive screening scenario to a most intrusive screening scenario.

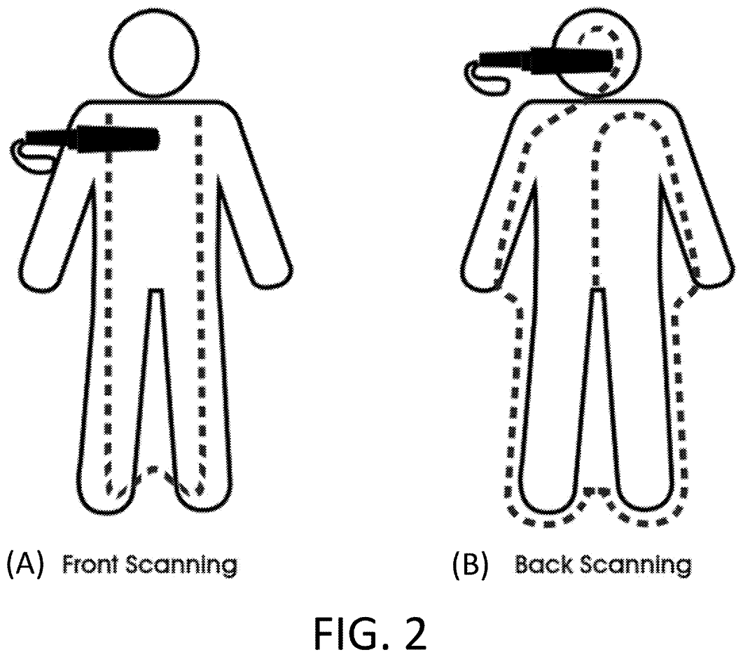

FIG. 2 shows an example of a visual of a noninvasive pat down of a person using a handheld metal detector wand for (A) front scanning and (B) back scanning.

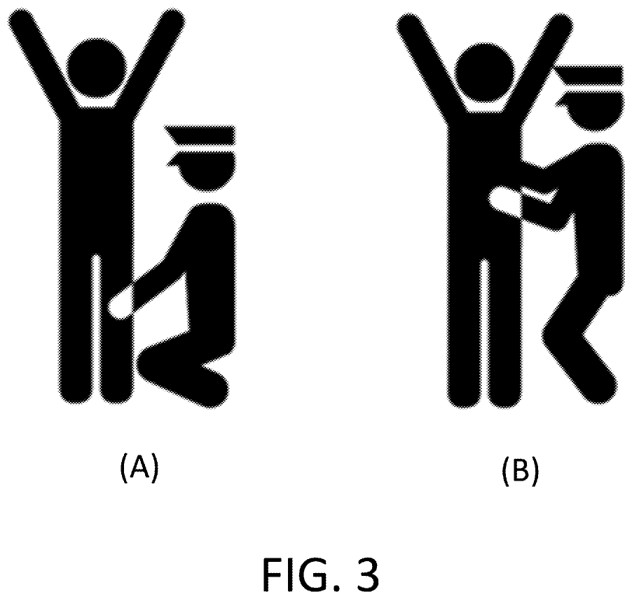

FIG. 3 shows an example of a visual of an invasive pat down of the (A) lower body and (B) upper body of a person.

### Solution Level 2—Animated Graphics (Electronic)

A second solution level (Level 2 solution) of the communication solutions system involves generating animated video graphics in 2D or 3D or a filmed live action video demonstrating the necessary pat down to communicate to the passenger what the security officer is requesting. The security officer may select the appropriate pat down procedure from a start menu on the video component/subsystem of the communication solutions system.

To expand on this scenario, the communication solutions system could be connected to the results of the security screening system such that a secondary screen would bring up the appropriate video graphics (i.e., communication solutions content) to play based on the alarms displayed on the screening system. In certain situations, such as airport security screening in which the TSA (Transportation Security Administration) security screeners are all closed systems, there would be a requirement that the communication solutions system not be connected to any external networks for security and privacy purposes. To allow the communication solutions system to pull information from the screening system to cue up the correct videos AND be connected to a searchable ID database (or information from boarding passes) of passengers, that database then must be built and stored locally. This is to protect the raw images of the passengers. This would not apply to other security checkpoints that are not under the same rules of the TSA. The specific requirement under the TSA does not apply generally or broadly to other situations according to other embodiments.

If multiple locations to be inspected are displayed on an alarm box, a screen showing a snapshot of each pat-down of the multiple locations will be displayed. The security officer would show this to the passenger before playing the first video of multiple videos of the multiple pat-downs. After the video is completed, the TSO would proceed to the next video. In this way, the passenger will watch all videos corresponding to the pat-downs of the multiple locations that need to be inspected. The security officer may have the option of specifying the sequence of the multiple videos to be played, for instance, based on the actual sequence of screening processes to be performed or the level of intrusiveness from the lowest to the highest. The arrangement of the communication solutions content can be performed manually by the security officer or automatically by a processor. One example involves arranging the videos to be presented in a sequential order from a least intrusive screening scenario to a most intrusive screening scenario.

### Solution Level 3—Language Selection

Coupled with the Level 2 solution, a Level 3 solution of the communication solutions system involves the use of a simple start screen inquiring about the passenger's native language and allowing a voice-overlay on the animated video or filmed video to describe the process. Alternatively, coupled with the Level 1 solution, the Level 3 solution involves the use of an audio-visual display to provide a voice-overlay on the flash cards shown on the display to describe the enhanced screening or additional screening process.

The language options displayed on the start screen may be a preset fixed list or a list that is generated (programmed automatically or entered manually) based on the location of the airport and the typical demographic of the traveling public in that region. If the communication solutions system can be networked, for example, it can use the passenger's ID or boarding pass (e.g., by scanning the ID or accessing an ID database) to determine a targeted list of languages that the passenger is likely to understand and from which one or more may be selected.

At the end of the video(s), a set of predetermined or preset questions and/or answers may be displayed in the appropriate language(s) for the security officer and the passenger, which is then quickly translated to the opposite language when selected, allowing the other person to read the translation and then select the appropriate response. In another embodiment, the communication solutions system may read the question aloud for any hearing-impaired passengers. In yet another embodiment, a refreshable, dynamic braille system may be integrated with the communication solutions system for visually impaired passengers. An example of such a braille system is the Monarch Braille Tablet, which is a refreshable multiline braille and tactile graphics device. Braille displays may be supported by user interface devices such as iPhone, iPad, and iPod touch.

### Solution Level 4—Language Recognition

A fourth solution level of the communication solutions system involves the use of language recognition software in place of or in combination with the language selection option. One way to utilize a language recognition software is to prompt the passenger to say at least one specific word or more typically a series of specific words into a microphone (such as the type built into cell phones and tablets). A voice and language recognition software may be developed or selected and used to identify the language being spoken by the passenger.

The communication solutions system may display a confirmation page (“Do you understand English?” with a “Yes” button and a “No” button). The “Yes” button may be represented by a “Yes” emoji such as a “Thumbs up” or a “Check mark.” The “No” button may be represented by a “No” emoji such as a “Thumbs down” (or a “Prohibited” on top of a “Thumbs up”) or a “Cross mark.” If the answer is “no,” the passenger will not be able to understand the language on the screen and thus will not be able to answer. The security officer may select a button to display another language close to the first. If the language cannot be identified, the security officer may revert to Level 1 (cards only) or Level 2 (animations only) or Level 3 (menu of languages). If the passenger selects yes, it will then follow the same process as Level 3 with animations and pre-decided or preset prompts/questions/answers.

In some embodiments, an ID searchable database may be used in combination with this technique to narrow down the most likely languages for the passenger. To narrow down the possible languages for the passenger, the passenger's ID or boarding pass may be scanned/read and compared to a database of known IDs and the languages related to the place of origin associated with any given known ID. As stated above, for TSA, this would need to be a local database and not cloud-based (as such, continuous updates of boarding pass information would not be possible). TSA may have their own local network which could store the database, but it would not be connected outside of the airport. If a cloud-based ID searchable database is utilized, then the communication solutions system cannot connect directly to the screener and the security officer would have to manually select the appropriate videos to show the passenger.

### Solution Level 5—Screening Expansion

The same methodology and techniques of the communication solutions system described above may be applied to other screening situations such as the resolution of baggage alarms as a form of screening expansion. On occasion, the security officers may need to discuss with the passenger an item in the passenger's baggage which has triggered an alarm and the alarm warning needs to be resolved.

Furthermore, in another form of screening expansion, the same methodology and techniques of the communication solutions system described above may be used in a variety of settings such as emergency rooms, police departments, museums and tourist attractions, sporting events, and any place with a security checkpoint or an access control touchpoint.

### Communication Solutions System and Method

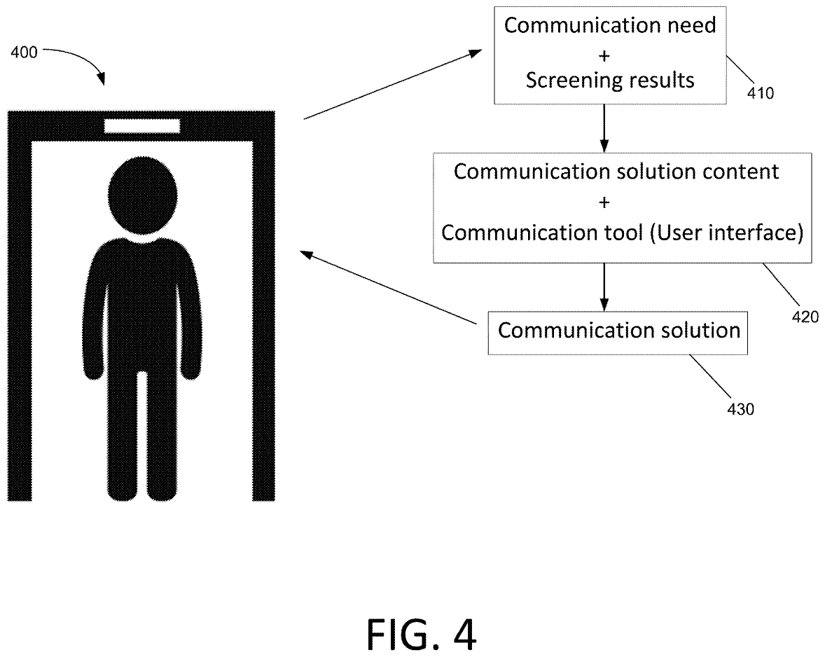

FIG. 4 shows an example of an approach to develop a communication solution at an access control screening 400. The approach starts with obtaining the screening results of an individual and identifying the communication need of that individual (step 410). Based on the screening results and the communication need, the approach determines the appropriate communication solutions content to address the screening results and selects the appropriate communication tool (user interface) to communicate the communication solutions content to meet the communication need (step 420). This provides a suitable communication solution to be presented to the individual (step 430).

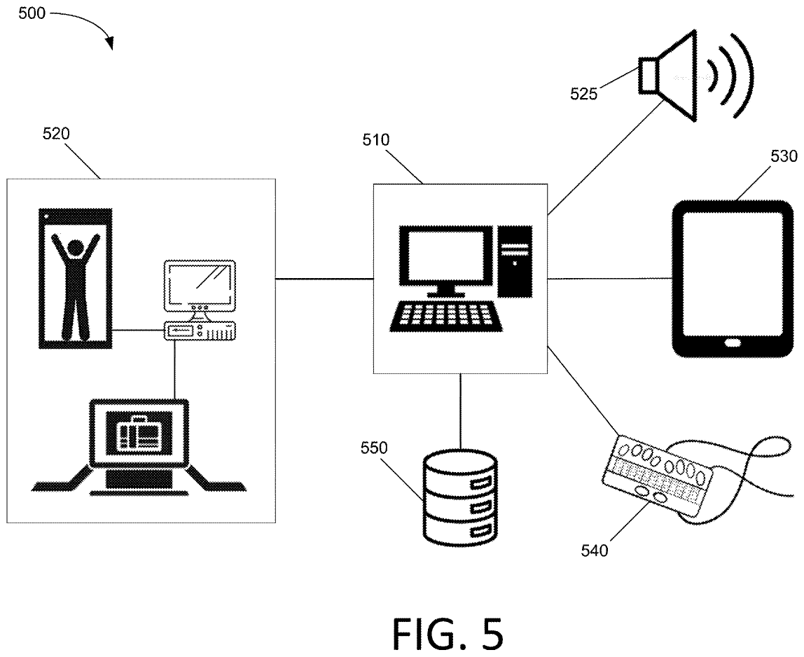

FIG. 5 shows an example of a system 500 of providing communication solutions at an access control checkpoint. A communication solutions system 510 communicates with a screening system 520, for instance, to receive screening results including screening alarm or warning. A screening result may include information identifying additional, secondary, or enhanced screening of an individual or an object (e.g., luggage) associated with the individual. The communication solutions system 510, with or without external input (e.g., from a security officer or a monitoring device), identifies a communication need to provide a communication solution to an individual being screened at the access control checkpoint and selects a communication solutions content from a plurality of communication solutions contents stored in a computer storage to provide to the individual based on the communication need. The communication solutions system 510 is coupled with a plurality of user interfaces including, for example, an audio device 525, a visual or audio-visual device 530, a dynamic or refreshable braille device 540, and the like. The communication solutions system 510 communicates with a computer storage device 550 which may be a local device via a local network or a remote device via an external network. The communication solutions system 510 may receive input, from the screening system 520, identifying a screening protocol to be performed on the individual at the access control checkpoint and select one or more communication solutions contents to provide to the individual based on the screening protocol and the communication need.

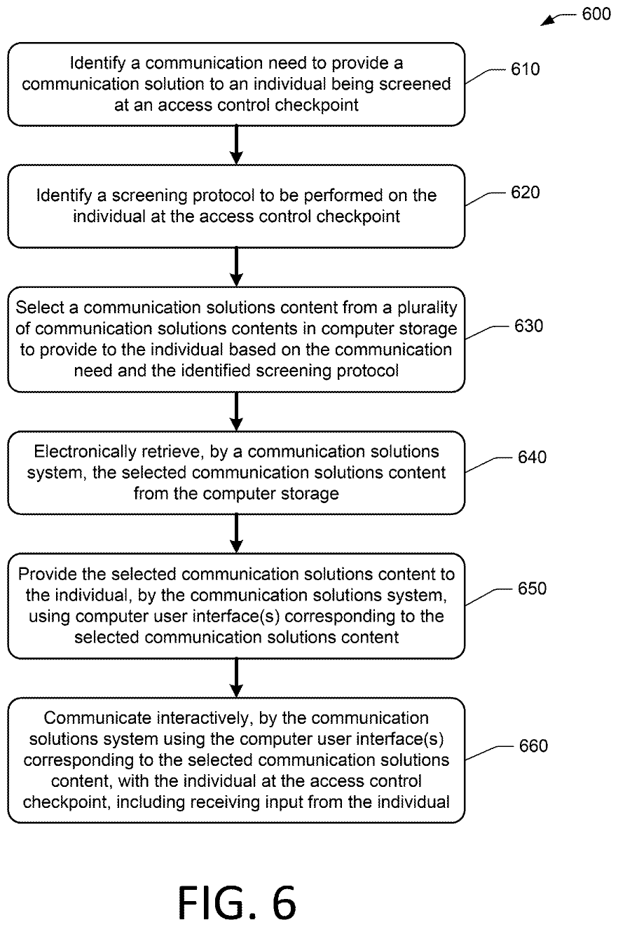

FIG. 6 shows an example of a flow diagram 600 illustrating a communication solutions method. Step 610 involves identifying a communication need to provide a communication solution to an individual being screened at an access control checkpoint. In one embodiment, identifying the communication need may include visually observing the individual at the access control checkpoint to identify a communication problem with the individual; and/or audibly detecting a communication impairment with the individual at the access control checkpoint. Audibly detecting the communication impairment may include electronically recognizing a language spoken by the individual at the access control checkpoint. In another embodiment, identifying the communication need may include electronically accessing, by the communication solutions system, a database containing identity information of the individual, which includes at least one of biographic information, physical impairment information, or medical condition information; and identifying the communication need based on the identity information of the individual.

Step 620 involves identifying a screening protocol to be performed on the individual at the access control checkpoint. Step 630 involves selecting a communication solutions content from a plurality of communication solutions contents stored in a computer storage to provide to the individual based on the communication need and the identified screening protocol. The plurality of communication solutions contents were created, prior to identifying the communication need, to communicate a plurality of screening scenarios to be performed to determine whether to grant access to the individual at the access control checkpoint. Each communication solutions content utilizes one or more corresponding computer user interfaces to communicate the communication solutions content.

In one embodiment, selecting the communication solutions content may include receiving an input, by the communication solutions system, from a screening officer at the access control checkpoint to be used in selecting the communication solutions content. In another embodiment, selecting the communication solutions content may include automatically selecting the communication solutions content, by the communication solutions system, without any human input.

The plurality of communication solutions contents may include at least one of: visual images to be displayed on an electronic display; an audio output to be played back on an audio device; an audio-visual output to be displayed on an electronic audio-visual output device; or a braille output to be provided to a refreshable braille device.

Step 640 involves electronically retrieving, by a communication solutions system, the selected communication solutions content from the computer storage. Step 650 involves providing the selected communication solutions content to the individual, by the communication solutions system, using one or more computer user interfaces corresponding to the selected communication solutions content. Step 660 involves communicating interactively, by the communication solutions system using the one or more computer user interfaces corresponding to the selected communication solutions content, with the individual at the access control checkpoint, including receiving user input from the individual.

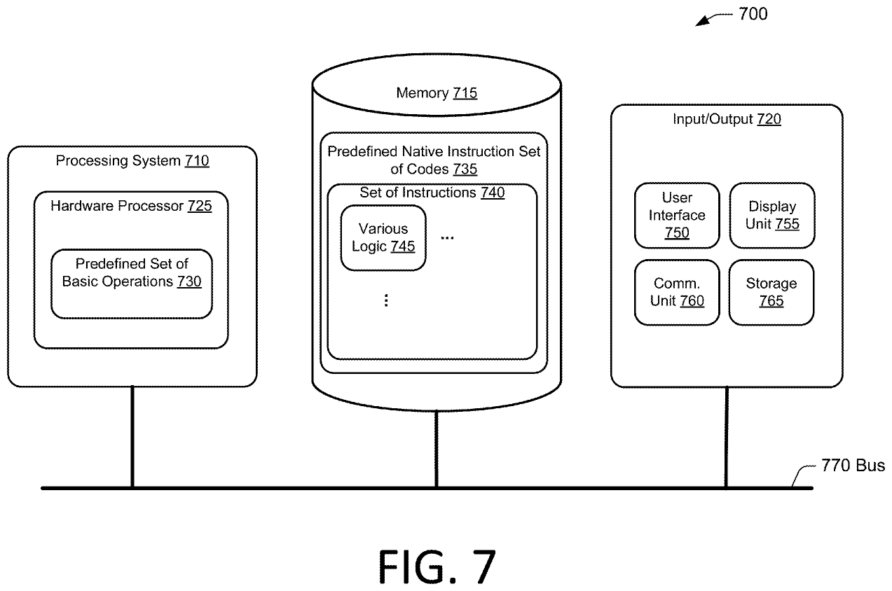

FIG. 7 illustrates a computing system 700 including logic according to an embodiment. The computing system 700 includes a processing system 710 having a hardware processor 725 configured to perform a predefined set of basic operations 730 by loading corresponding ones of a predefined native instruction set of codes 735 as stored in the memory 715. The computing system 700 further includes input/output 720 having user interface 750, display unit 755, communication unit 760, and storage 765. The computing system 700 can be used to implement some or all of the processes or operations of the pre-checkpoint pressure mapping system 120, checkpoint pressure mapping system 153, and sensitive area pressure mapping system 172 in FIG. 1 and FIG. 2, including, for example, the pre-checkpoint monitoring process of FIGS. 3A-3B, the pre-scanning monitoring process of FIG. 4, and/or the scanning monitoring process of FIG. 5.

The memory 715 is accessible to the processing system 710 via the bus 770. The memory 715 includes the predefined native instruction set of codes 735, which constitute a set of instructions 740 selectable for execution by the hardware processor 725. In an embodiment, the set of instructions 740 include logic 745 representing various processor logic and/or modules. An example of such logic 745 is set forth in greater detail with respect to the flow diagrams illustrated in FIGS. 3A to 6. Each of the above-mentioned algorithms (e.g., MMWI, neutron imaging, and other detection algorithms and other imaging algorithms) can be a separate system or a module in an overall computer system 700. The various logic 745 is stored in the memory 715 and comprises instructions 740 selected from the predefined native instruction set of codes 735 of the hardware processor 725, adapted to operate with the processing system 710 to implement the process or processes of the corresponding logic 745.

A hardware processor may be thought of as a complex electrical circuit that is configured to perform a predefined set of basic operations in response to receiving a corresponding basic instruction selected from a predefined native instruction set of codes. The predefined native instruction set of codes is specific to the hardware processor; the design of the processor defines the collection of basic instructions to which the processor will respond, and this collection forms the predefined native instruction set of codes. A basic instruction may be represented numerically as a series of binary values, in which case it may be referred to as a machine code. The series of binary values may be represented electrically, as inputs to the hardware processor, via electrical connections, using voltages that represent either a binary zero or a binary one. These voltages are interpreted as such by the hardware processor. Executable program code may therefore be understood to be a set of machine codes selected from the predefined native instruction set of codes. A given set of machine codes may be understood, generally, to constitute a module. A set of one or more modules may be understood to constitute an application program or “app.” An app may interact with the hardware processor directly or indirectly via an operating system. An app may be part of an operating system.

A computer program product is an article of manufacture that has a computer-readable medium with executable program code that is adapted to enable a processing system to perform various operations and actions. Non-transitory computer-readable media may be understood as a storage for the executable program code. Whereas a transitory computer-readable medium holds executable program code on the move, a non-transitory computer-readable medium is meant to hold executable program code at rest. Non-transitory computer-readable media may hold the software in its entirety, and for longer duration, compared to transitory computer-readable media that holds only a portion of the software and for a relatively short time. The term, “non-transitory computer-readable medium,” specifically excludes communication signals such as radio frequency signals in transit. The following forms of storage exemplify non-transitory computer-readable media: removable storage such as a USB disk, a USB stick, a flash disk, a flash drive, a thumb drive, an external SSD, a compact flash card, an SD card, a diskette, a tape, a compact disc, an optical disc; secondary storage such as an internal hard drive, an internal SSD, internal flash memory, internal non-volatile memory, internal DRAM, ROM, RAM, and the like; and the primary storage of a computer system.

Different terms may be used to express the relationship between executable program code and non-transitory computer-readable media. Executable program code may be written on a disc, embodied in an application-specific integrated circuit, stored in a memory chip, or loaded in a cache memory, for example. Herein, the executable program code may be said, generally, to be “in” or “on” a computer-readable media. Conversely, the computer-readable media may be said to store, to include, to hold, or to have the executable program code.

The inventive concepts taught by way of the examples discussed above are amenable to modification, rearrangement, and embodiment in several ways. Accordingly, although the present disclosure has been described with reference to specific embodiments and examples, persons skilled in the art will recognize that changes may be made in form and detail without departing from the spirit and scope of the disclosure. The access control touchpoint may be placed at various locations to control ingress to and/or egress from a variety of venues other than airports, including, for instance, sporting event and concert arenas, stadiums, auditoriums, dormitories, hotels, museums, buildings (residential, commercial, or government), parking structures, casinos, stores, restaurants, voting or polling precincts, hospitals, medical facilities, or the like.

Certain attributes, functions, steps of methods, or sub-steps of methods described herein may be associated with physical structures or components, such as a module of a physical device that, in implementations in accordance with this disclosure, make use of instructions (e.g., computer executable instructions) that are embodied in hardware, such as an application specific integrated circuit, or that may cause a computer (e.g., a general-purpose computer) executing the instructions to have defined characteristics. There may be a combination of hardware and software such as processor implementing firmware, software, and so forth so as to function as a special purpose computer with the ascribed characteristics. For example, in embodiments a module may comprise a functional hardware unit (such as a self-contained hardware or software or a combination thereof) designed to interface the other components of a system such as through use of an API. In embodiments, a module is structured to perform a function or set of functions, such as in accordance with a described algorithm. This disclosure may use nomenclature that associates a component or module with a function, purpose, step, or sub-step to identify the corresponding structure which, in instances, includes hardware and/or software that function for a specific purpose. For any computer-implemented embodiment, “means plus function” elements will use the term “means;” the terms “logic” and “module” and the like have the meaning ascribed to them above, if any, and are not to be construed as means.

The claims define the invention and form part of the specification. Limitations from the written description are not to be read into the claims.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

What is claimed is:

1. A communication solutions method comprising:
identifying a communication need to provide a communication solution to an individual being screened at an access control checkpoint;
selecting, for the communication solution to the individual being screened, a communication solutions content from a plurality of communication solutions contents stored in a computer storage to provide to the individual based on the communication need, the plurality of communication solutions contents having been created, prior to identifying the communication need, to communicate a plurality of screening scenarios to be performed to determine whether to grant access to the individual at the access control checkpoint, each communication solutions content utilizing one or more corresponding computer user interfaces to communicate the communication solutions content;
electronically retrieving, by a communication solutions system, the selected communication solutions content from the computer storage; and
providing the selected communication solutions content to the individual, by the communication solutions system, using the one or more corresponding computer user interfaces corresponding to the selected communication solutions content.

2. The communication solutions method of claim 1, wherein identifying the communication need comprises one or more of:
visually observing, by a screening officer at the access control checkpoint, the individual at the access control checkpoint to identify a communication problem with the individual; or
audibly detecting, by the screening officer at the access control checkpoint, a communication impairment with the individual at the access control checkpoint.

3. The communication solutions method of claim 2, wherein identifying the communication need further comprises:
electronically accessing, by the communication solutions system, a database containing identity information of the individual, which includes at least one of biographic information, physical impairment information, or medical condition information; and
identifying the communication need based on the identity information of the individual.

4. The communication solutions method of claim 2, wherein audibly detecting the communication impairment comprises:
electronically recognizing a language spoken by the individual at the access control checkpoint.

5. The communication solutions method of claim 1, wherein the plurality of communication solutions contents comprise at least one of:
visual images to be displayed on an electronic display;
an audio output to be played back on an audio device;
an audio-visual output to be displayed on an electronic audio-visual output device; or
a braille output to be provided to a refreshable braille device.

6. The communication solutions method of claim 1, wherein selecting the communication solutions content comprises:
receiving an input, by the communication solutions system, from a screening officer at the access control checkpoint to be used in selecting the communication solutions content.

7. The communication solutions method of claim 1, wherein selecting the communication solutions content comprises:
automatically selecting the communication solutions content, by the communication solutions system, without any human input.

8. The communication solutions method of claim 1, further comprising:
arranging the communication solutions content to be presented in a sequential order to the individual, from a least intrusive screening scenario to a most intrusive screening scenario.

9. The communication solutions method of claim 1, further comprising:
communicating interactively, by the communication solutions system using the one or more corresponding computer user interfaces corresponding to the selected communication solutions content, with the individual at the access control checkpoint, including receiving user input from the individual.

10. The communication solutions method of claim 1, further comprising:
identifying a screening protocol to be performed on the individual at the access control checkpoint; and
selecting the communication solutions content based on the screening protocol and the communication need.

11. A communication solutions system comprising a processor, a memory, and a program executable by the processor to:
identify a communication need to provide a communication solution to an individual being screened at an access control checkpoint;
select, for the communication solution to the individual being screened, a communication solutions content from a plurality of communication solutions contents stored in a computer storage to provide to the individual based on the communication need, the plurality of communication solutions contents having been created, prior to identifying the communication need, to communicate a plurality of screening scenarios to be performed to determine whether to grant access to the individual at the access control checkpoint, each communication solutions content utilizing one or more corresponding computer user interfaces to communicate the communication solutions content;
electronically retrieve the selected communication solutions content from the computer storage; and
provide the selected communication solutions content to the individual using the one or more corresponding computer user interfaces corresponding to the selected communication solutions content.

12. The communication solutions system of claim 11, wherein identifying the communication need comprises one or more of:
receiving an input from a screening officer at the access control checkpoint who visually observes the individual at the access control checkpoint to identify a communication problem with the individual; or
receiving an input from the screening officer at the access control checkpoint who audibly detects a communication impairment with the individual at the access control checkpoint.

13. The communication solutions system of claim 12, wherein identifying the communication need further comprises:
electronically accessing a database containing identity information of the individual, which includes at least one of biographic information, physical impairment information, or medical condition information; and
identifying the communication need based on the identity information of the individual.

14. The communication solutions system of claim 12, wherein audibly detecting the communication impairment comprises:
electronically recognizing a language spoken by the individual at the access control checkpoint.

15. The communication solutions system of claim 11, wherein the plurality of communication solutions contents comprise at least one of:
visual images to be displayed on an electronic display;
an audio output to be played back on an audio device;
an audio-visual output to be displayed on an electronic audio-visual output device; or
a braille output to be provided to a refreshable braille device.

16. The communication solutions system of claim 11, wherein selecting the communication solutions content comprises:
receiving an input, by the communication solutions system, from a screening officer at the access control checkpoint to be used in selecting the communication solutions content.

17. The communication solutions system of claim 11, wherein selecting the communication solutions content comprises:
automatically selecting the communication solutions content, by the communication solutions system, without any human input.

18. The communication solutions system of claim 11, wherein the program is executable by the processor to:
arrange the communication solutions content to be presented in a sequential order to the individual, from a least intrusive screening scenario to a most intrusive screening scenario.

19. The communication solutions system of claim 11, wherein the program is executable by the processor to:
communicate interactively, by the communication solutions system using the one or more corresponding computer user interfaces corresponding to the selected communication solutions content, with the individual at the access control checkpoint, including receiving user input from the individual.

20. The communication solutions system of claim 11, wherein the program is executable by the processor to:
receive input, from a screening system, identifying a screening protocol to be performed on the individual at the access control checkpoint; and
select the communication solutions content based on the screening protocol and the communication need.
